(19) United States
(12) Patent Application Publication
(10) Pub. No.: US 2023/0347526 A1
(43) Pub. Date: Nov. 2, 2023

(54) METHOD AND ASSEMBLY FOR CALIBRATING PARALLEL KINEMATICS

(71) Applicant: PHYSIK INSTRUMENTE (PI) GMBH & CO. KG, Karlsruhe (DE)

(72) Inventor: Erik Mankin, Karlsruhe (DE)

(21) Appl. No.: 18/025,785

(22) PCT Filed: Aug. 9, 2021
(86) PCT No.: PCT/EP2021/072185

§ 371 Date: Mar. 10, 2023

(30) Foreign Application Priority Data
Sep. 16, 2020 (DE) 10 2020 124 136.4

(51) Int. Cl. B25J 9/16; B25J 9/00

(52) U.S. Cl. CPC B25J 9/1692; B25J 9/0054; B25J 9/1623

(57) ABSTRACT

The invention relates to a method for a usage-related calibration of parallel kinematics with a programmable actuation, said method having the steps of: releasably attaching a separate pose marking element in a uniquely defined position and angular orientation on the platform or on a base of the parallel kinematics so as to be secured against tilting using a kinematic coupling, detecting the pose of the pose marking element using a pose detection device, and determining a pose marking coordinate system in the coordinate system of the pose detection device, determining a calibrated reference coordinate system of the parallel kinematics from the pose marking coordinate system on the basis of a specified first coordinate transformation rule, and storing the calibrated reference coordinate system of the parallel kinematics in the actuator thereof or a measuring software, detecting the pose of the world coordinate system using a coordinate measuring device, determining the world coordinate system in the coordinate system of the pose detection device, storing the pose of the world coordinate system, and making available the two stored coordinate systems or the coordinate transformation between the two coordinate systems in order to adapt the hexapod movements with respect to the world coordinate system.

The invention relates to a method for a usage-related calibration of parallel kinematics with a programmable actuation, as well as an assembly for executing this method.

So-called parallel kinematics, in particular hexapods, also referred to as Stewart platforms, are used inter alia in highly precisely positioning parts in production processes, and their field of application has drastically expanded during the last years. For newly developed fields of application, for example, in semiconductor technology and the manufacture of integrated circuits, highest precision is required.

A special case of such parallel kinematics having found broad applicability in practice, are so-called hexapods.

The document US 2013/0 006 421 A1 discloses an arrangement of usage-related calibrating parallel kinematics featuring a programmable control with a pose marking element and a kinematic coupling for releasably mounting the pose marking element in a tilt-protected manner to the platform of the parallel kinematics in a clearly specified position and angular position. Corresponding arrangements can also be taken from the printed publications WO 2010/128 441 A1, DE 10 2028 124 898 A1 as well as DE 198 58 154 A1.

Essential terms used in the present disclosure will be explained in the following.

Reference coordinate system/ Reference coordinate systems

As reference coordinate systems of a parallel robot those coordinate systems are designated to which the commanded poses are related. Usually, there is an excellent reference coordinate system which is predefined in the construction plans, the precise position of which, however, can be moved to another point depending on the calibration method. If in case of a parallel robot, none of the reference coordinate systems has been characterized as a canonical reference coordinate system, one of the coordinate systems will arbitrarily be designated a canonical reference system, since an excellent reference coordinate system is designated in this description. The reference coordinate system defines the pivot point in the zero pose by its zero point, and it defines both the Cartesian movement directions and the zero angles by its orientation, to which the indication of the Euler angles is related.

### POSE MARKING

A pose marking is a marking at a rigid element with the help of which a pose in space can be measured relative to a reference pose of this rigid element. Pose markings enable a rigid element to have a coordinate system attached, the origin and orientation of which can be determined measurement-technologically by means of the pose marking. As pose markings, for example, three balls are suited that are not arranged collinearly and fixedly connected to the rigid element. The coordinates of their centre points allow the position of an attached coordinate system to be defined. Another pose marking can be realized by a fixed cube since a coordinate system can already be determined at three pairwise non parallel planes.

### SPACE REGISTRATION

A space registration is a prescription how rigid elements have, based on their pose marking, an attached coordinate system assigned. By means of a space registration, a pose can be assigned to a rigid element which has a pose marking, if a reference coordinate system exists in which its pose can be defined.

### AVAILABLE COORDINATE SYSTEM

A coordinate system is available, when its position and orientation relative to a space registration is defined by a coordinate transformation.

### AVAILABLE REFERENCE COORDINATE SYSTEM

An available reference coordinate system of a parallel robot is a coordinate system, the original coordinates and the orientation of which can be indicated relative to the first coordinate system of a calibration artefact, if this is connected to a nacelle by a kinematic interface, and the parallel robot has taken an excellent pose intended for that, which as a rule is its initializing pose.

### KINEMATIC INTERFACES

Kinematic interfaces are devices for the rigid and releasable connection of two rigid elements, wherein the two rigid elements can be exactly reproducible and be mutually fixed deterministically into the same pose. This device consists of two parts that are adapted to one another, designated in this printed publication as interface parts, wherein each of the two rigid elements to be connected to one another has such an interface, and the connection is caused by the kinematic interface.

The interface parts are adapted to one another according to the concept of “plug and socket” in electrical engineering. It is essential that the plug and socket can be coupled to one another in just one way, what excludes symmetries as it is the case in a Euro plug.

Appropriately, there is the possibility of easily releasable and easily re-arrestable connecting the interface parts. Self-arresting, locking, magnetically fixing and similar are advantageous configurations.

Interface parts are functional facilities of rigid elements. Kinematic interfaces serve for creating a rigid connection of two rigid elements, whereby a new rigid element is generated. For this purpose, each of the two rigid elements needs to have an interface part. Kinematic interfaces thus offer a connection possibility for rigid elements. Kinematic interfaces are constructed such that the connection is releasable and in this case as deterministic and reproducible as possible, and the connection is rigid and stiff. The kinematic interfaces should be dimensionally stable relative to forces and moments.

A first class of kinematic interfaces bears the designation “kinematic coupling”. In a preferred embodiment of the invention, “kinematic couplings” are used. In a further preferred embodiment, kinematic couplings of the constructive type “Maxwell coupling” are employed, designated in this printed publication as “three groove kinematic coupling”. In the exemplary embodiments and representations “three groove kinematic couplings” are exemplarily used without restricting generality. A “three groove kinematic coupling” is shown in FIG. 5.

In case of positive engagement, each of the three balls of the ball part has a point contact at two points of a groove of the groove part, so that contacting is given at six points in case of positive engagement. Then there is a statical determination.

This first class of kinematic interfaces have statical determination, and for this purpose offer the highest precision and suitability in the context of the invention.

A second class of kinematic interfaces bears the designation “quasi-kinematic coupling”. In a further preferred embodiment, kinematic interfaces of this class are used according to the invention.

A third class of kinematic interfaces are those which can neither be assigned to the class of “kinematic couplings” nor to the class of “quasi-kinematic couplings”. In a further preferred embodiment of the invention, kinematic interfaces of this kind are used. Most of the time, these interfaces are form-fit connections.

Without restricting generality, the interface parts of the kinematic interface are designated in this printed publication clearly as a ball part or groove part according to the interface parts in the “three groove kinematic coupling”.

### INTERFACE-BEARING ARTEFACT

An interface-bearing artefact is a rigid element provided with an interface part.

### REFERENCE ARTEFACT

A reference artefact is an interface-bearing artefact featuring a pose marking to which a space registration is added. It thus has a defined coordinate system attached designated to be the first coordinate system of the reference artefact. Reference artefacts may be cuboids the outer surfaces of which represent a pose marking. Optionally, the cuboids may be suited to move a mass put thereon. In particular, plate-shaped cuboids can have markings relative to their spatial marking impressed on their upper side in the direction of the outer surfaces. In a preferred embodiment, the pose marking consists of stopper surfaces on the plate-shaped cuboids.

### CALIBRATING ARTEFACT

The calibrating artefact is a principally arbitrarily selected reference artefact serving the purpose of relating the first coordinate system of all reference artefacts to one another. Where the position of the first coordinate system of a reference artefact is located as compared to the position of the first coordinate system of the calibrating artefact, represented as a date of 6 real numbers describing a coordinate transformation, is a date each reference artefact has. If such a registered reference artefact is attached to the groove part of a “three groove kinematic coupling, a coordinate system may be consequently defined based on its pose marking, the position of which is known in relation to the calibrating artefact. Thus, the position of the reference coordinate system may also be determined, when its position is known in relation to the calibrating artefact.

### MOUNTING ARTEFACT

A mounting artefact is a reference artefact serving the purpose of, for example, receiving a tool (a clamp for fibre mounting, mounting of a probe, mounting of a milling cutter), a work piece or a measuring device. As the second coordinate system of the mounting artefact, the place of action of the tool is designated here, the coordinate system of the work piece or the measuring point of the measuring device. The profit of such an artefact is that the second coordinate system of the mounting artefact may always be indicated immediately to the reference coordinate system of the respective hexapod. The coordinate transformation between the first and the second coordinate system of a mounting artefact usually may be determined by means of a coordinate measuring machine. Usually, the use of the pose marking of the mounting artefact can be renounced of, then the tool, the work piece or the measuring device are regarded themselves as a pose marking due to their shape, so that the first and second coordinate system coincide.

A further preferred configuration of mounting artefacts are mirror mountings, the surface normal of which is oriented in relation to the calibrating artefact. These mirror artefacts facilitate interferometric measurements at the hexapods, since the mirror may be oriented according to the beam orientation of the laser. Artefacts of this kind facilitate the qualification of hexapod precisions. Since the control of hexapods can read out its leg lengths and may hence calculate the pose of a hexapod, hexapods themselves are pose detecting means. Thus, there is the possibility to indicate the normal vector of the mirror even in the reference coordinate system when the hexapod itself is not in its initialization pose but has been oriented on a laser beam.

A further preferred configuration of mounting artefacts are geometric bodies which serve for the orientation of a hexapod on the coordinate system of an apparatus or an arrangement, in that these bodies define the point of action of a measurement or manipulation. Here, as well, the possibility of using hexapods to detect poses is used, the mentioned coordinate system may be referred to the reference coordinate system of the hexapod.

A further preferred configuration of mounting artefacts are geometric bodies which serve for stopping in order to relate world coordinate systems to the reference coordinate system of the hexapod. Plates having defined stopping surfaces or else angled rods, for example, should be mentioned. Also, these are used in turn for hexapods to be able to measure their own poses, and the world coordinate system therefore is known in the reference coordinate system of the hexapod.

Furthermore, reference artefacts may be constructed in a way that tools, stoppers, work pieces can be fixed in an adjustable and arrestable way so as to make the use of mounting artefacts more flexible. One example here would be spherical head clamps, as they are used in camera mountings. After such a dislocation of stoppers etc., a new relation to the calibrating artefact needs to be established with a pose measuring device.

Mounting artefacts according to their definition are also reference artefacts, and thus have a pose marking. In certain mounting artefacts, functionality would also be given without pose marking, for example, in the mirror-bearing mounting artefacts in which only the normal vector of the mirror/s is relevant. As far as the functionalities described above of mounting artefacts would be given even without a pose marking, therefrom derived artefacts having no pose marking can also be used according to the invention.

Movements in the illustrative space regarded and referred to also as coordinate transformation depending on the context, form a group, the special Euclidean group. This mathematical group property can be used unrestrictedly in using, according to the invention, reference artefacts and mounting artefacts for seizing the reference coordinate system. Reference coordinate systems of hexapods, first coordinate systems of various reference artefacts etc., therefore may be mutually related in a simple manner.

### IN THE ATTACHED DRAWINGS ARE

FIGS. 1 to FIG. 4 representations for explaining the state of the art and the task of the invention,

FIGS. 5 to FIG. 13 representations for explaining embodiments of the method according to the invention and the assembly according to the invention,

FIG. 15 to FIG. 16 representations for using the invention in parallel robots, and

FIG. 17 a representation of an exemplary reference artefact.

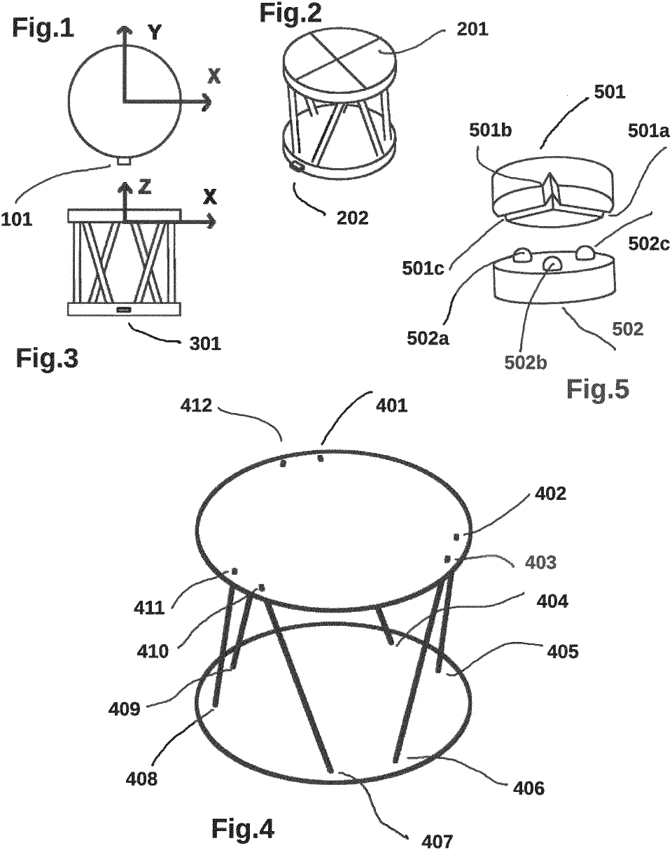

FIGS. 1 to 3 are perspective representations of a hexapod. Drawings of this kind may be found in the technical manuals to hexapods. When the hexapod is used, the position of the coordinate system designated here as a reference coordinate system plotted in FIG. 1 and FIG. 3 is of particular importance.

The origin of this reference coordinate system defines the so-called pivot point, thus that point around which the upper platform turns when rotational movements are commanded. The orientation of this coordinate system defines the zero angles for all angular movements. The coordinate axes of the coordinate system define the directions of the Cartesian movements. So as to be able to indicate the pivot point and the directions of movement, the position and orientation of the reference coordinate system must be known accordingly. In this case, one relates in the state of the art to drawings, similar to those indicated in FIGS. 1 to 3, wherein the drawings in the manuals additionally contain dimension specifications.

In the example of FIGS. 1 to 3, the horizontal plane of the zero point of the coordinate system is located at the lower surface of the cylinder-shaped nacelle. Relative to the lower side of the platform, this height is given by the difference of the constructive height and the thickness of the nacelle, relative to the upper side of the nacelle one has to proceed in analogy. The zero point furthermore is located rotationally symmetrical to the cylindrical cover plate shown in FIG. 1. The directions of X and Y may be differentiated by the position of the cable connection 102, 202, 301, in addition there are auxiliary grooves 201 on the nacelle which are oriented in the X-direction or the Y-direction.

The just described localisation of the reference coordinate system by means of dimensioned technical drawings and determined on constructive groups such as bottom plate or nacelle, is state of the art.

If a hexapod is now used, movements in an external coordinate system, which is given, for example, by an experimental construction, or movements/orientations relative to a coordinate system attached to the platform are demanded, for example, that of a fibre mounting in fibre alignment. It is thus valid to be able to indicate the position and orientation of a given coordinate system so that movements can be made in a given coordinate system.

If a hexapod has only a low kinematic precision, the reference coordinate system may be temporarily related to other coordinate systems by means of measurement auxiliaries such as callipers for applications having only low demands on the positional precision.

If the hexapod, however, is intended to position highly-precisely, then the mentioned proceeding is defective. In the manufacture of the hexapod, highly precise dimensional tolerances therefore are only defined for kinematically relevant constructive parts. The kinematically relevant constructive parts specifically are the upper and lower leg articulations and the local vectors in the reference coordinate system, which are designated holder points. The bottom plate and the cover plate only have the function to connect these holder points in a rigid body, and thus are not manufactured in a highly precise manner. The outer forms of the hexapod thus only give a rough information on the position and orientation of the reference coordinate system, which must lead to imponderable uncertainties of the position and orientation of the reference coordinate system of the hexapod relative to external coordinate systems.

The position of the holder points relative to the reference coordinate system is shown in FIG. 4. Here, a hexapod is schematically shown, whose legs end in ball articulations, the pans of which are located in the nacelle and the base plate. The coordinates of the ball centres 401 to 412, indicated as local vectors relative to the constructively predetermined reference coordinate system as shown in FIG. 1 and FIG. 2, form the kinematic model of the hexapod. In the state of the art, the tasks in conjunction with the kinematic precision are exclusively in precisely determining the 12 local vectors of the ball centres relative to the constructively predetermined reference coordinate system.

Now, these local vectors of the holder points can be poorly measured with a coordinate measuring machine, which means that the position of the reference coordinate system, for example, in the coordinate system of a coordinate measuring machine can be determined only in a complicated and expensive manner. This means in the practical use of hexapods, that the position of the reference coordinate system relative to a predetermined coordinate system practically cannot be determined or only in a very expensive manner and always without precision.

The remedy to manufacture at least parts of the nacelle in a highly precise manner so as to gain an exact access to the reference coordinate system, is unknown in the state of the art. Since there are already basic and unsolved problems in the precision and calibration of hexapods, questions as to the exactly determinable position and orientation of the reference coordinate system are not seen and not treated in the state of the art. The task to make the reference coordinate system available, hitherto is not in the visual field of science. The problem of a precise reference of movements to an external coordinate system accordingly hitherto remains ignored and unsolved in technical engineering and research.

The mentioned problems with localizing the reference coordinate system appear in the work with hexapods. If one wants, for example, to measure the linearity of the hexapod movement in the X-direction and the occurring cross talks in the Y-and Z-directions, there are systematic deviations since there is no precise possibility to orientate the measuring coordinate system to the reference coordinate system of the hexapod. Analogous problems result in precision examinations of the angular rotation of the nacelle.

The inadequacies in the state of the art are shown impressively, for example, when a probe in the form of a round rod is intended to be moved along its core such as in surgeries in the inner skull. The Plücker line of the probe core and the tip of the probe are only determinable in an insufficient precise manner relative to the reference coordinate system. Lateral movements run obliquely to the Plücker line, and when rotations about the core of the probe are commanded, the core of the round rod strikes over a surface on the shell surface of a rotation hyperboloid.

When the hexapod is used, all the movements of the hexapod platform are subjected to uncertainties of this kind in the state of the art. Within the scope of manipulation of highly precise or ultraprecise hexapods, the availability of the reference coordinate system needs to be be used according to the invention.

The precision of parallel robots falls behind the expectations for decades. The approaches and measures known in the state of the art for precision regulation are unsatisfactory. In addition, the precision of these robots is afflicted already by the fact that no techniques have been developed by means of which the pose of a parallel robot and/or its simulateously moved load can be exactly and practicably related to a well-defined reference coordinate system. This reference coordinate system is not “available”.

Thus, all of the known kinematic calibrating measures in hexapods are not based on an available reference coordinate system. Without making the reference coordinate system available, calibrating measures are questionable and the result of calibrations is quite unsatisfactory. Indications as to the positioning accuracy lose their capacity due to the lacking availability of the reference coordinate system.

Broadly, kinematic calibrations of hexapods are based on a plurality of measurements of commanded poses by means of a pose detecting device and a subsequent evaluation, in which the measured poses are compared to the commanded poses. The coordinate system of a pose detecting device, however, is an auxiliary coordinate system, the position and orientation in space in principle may be determined arbitrarily, and there is no longer any importance after the pose measurements have been evaluated. The information items on the position of this coordinate system surviving the evaluation, consist of approximate statement of the position of individual constructive groups of the hexapods, when these have been detected by means of the pose detecting device.

In the state of the art, the temporary coordinate system of the pose detecting device is missed in the course of calibration to be exactly retained relative to a persistent available coordinate system of a hexapod. It follows immediately from this that even after a calibration in particular the directions of movement of the hexapod as well as the position of its pivot point can be indicated more or less in a vague manner.

The questions as to an available coordinate system does not pose itself in case of serial robots, since the poses of all of its moved members are a part of a single kinematic chain and must be known for realizing the end effector pose, wherein the poses of each single member are based on the pose of the previous member and the reference coordinate systems of the individual members have an objective realization in the articulations between the members. Therefore, except questions of the precision, it is naturally possible to dislocate a reference coordinate system in the foot base of the serial robot into the end effector and to find it there also objectively. The reference coordinate system here is always in one location on the kinematic chain. In parallel kinematics, however, closed kinematic chains are present and the point of action (TCP = Tool Centre Point) of parallel kinematics generally is not related to single kinematically relevant parts of a kinematic chain. In parallel kinematics, particular technical circumstances are given which aggravate the availability of the reference coordinate systems.

Parallel robots are intended to realize poses. This is described in that a coordinate system which in the initialization pose is identical to the reference coordinate system of the parallel robot, is brought into congruence with a second defined coordinate system by a general movement in space (rotation and translation). For parametrizing the position of this second coordinate system 6, common parameters have been selected in this printed publication. The first three parameters thereby indicated the Cartesian displacement and are designated X, Y and Z, the three last parameters indicate the Cardan angles and are designated U, V and W.

If the rotation of a rigid body is intended to be defined, a pivot point must be prescribed. The same rotation executed about another pivot point leads to another Cartesian final position of the rigid body. Since the pivot point is always defined in the coordinate system of the reference coordinate system of the parallel robot, inaccuracies or uncertainties in the position of this coordinate system will lead to pose deviations, in this case to Cartesian mistakes.

Furthermore, there is the requirement in positionings that the direction vectors of a Cartesian movement of a rigid body to be positioned which is entrained by the nacelle, may be indicated by means of the reference coordinate system or may be derived from a coordinate system of this rigid body. But if the reference coordinate system is not available, this requirement can only be fulfilled in an inadequate manner. Cartesian pose errors would be the consequence. A Cosine error in the direction of the movement and a cross talk in other movement directions occur.

Since the direction vectors of the Cartesian movement are at the same time the rotational axes of the Cardan angles, declinations of these axes lead to incorrect orientations after rotations of the bodies to be positioned. A declination in the direction vectors of the Cartesian movement moreover also leads to a mutual cross talk of the angles in the Euler angles, since the three Euler angles are related to one another.

The problematics of the lacking availability of the reference coordinate system will be explained in the following based on the example of the so-called parameter identification.

The most excessively discussed and still proposed method of increasing the precision is based on the so-called parameter identification. In this case, it is attempted to determine the true geometry parameters of the kinematics by a plurality of pose measurements, since the found kinematic pose deviations substantially are ascribed to geometry parameters that are realized in a deviating way. The principal non-observation introducing inaccuracies resulting from a non-available reference coordinate system lacking, is to be found in the descriptions, publications and fault evaluations of this calibrating method. Also, all of the other known calibrating methods of parallel robots feature this inaccuracy. The consequences of this inaccuracy show twice, once in the dubious nature of the calibration itself, and finally when obtained gains in precision of a calibration are intended to be used. This inadequacy is shown by way of example in the following on the example of the parameter identification.

All calibrations of parallel robots, irrespective whether they are based on the so-called parameter identification or on methods of fault mapping, are based on the comparison of measured poses to commanded poses.

For this purpose, coordinate systems introduced by means of defined pose markings are determined. These pose markings either may be derived from the outer shape of the nacelle, may be impressed into the nacelle or be on a rigid body attached to the nacelle.

After the measurements of the pose-transformed coordinate systems of the pose markings, these coordinate systems each need poses to be assigned.

In such an assignation, the pose markings are related to a constructively provided reference coordinate system of the hexapod. This is improvised in the state of the art temporarily by measurement and estimations, since this reference coordinate system has no concrete embodiment.

In total, a reference coordinate system thus is referred to which has been gained heuristically and is completely fictive.

As to the pose markings on rigid bodies attached to the nacelle, it has to be noted that such attachments according to the invention would have to be made precisely, reproducibly and deterministic in the right way, which in practice requires the use according to the invention of a kinematic interface. Only the method according to the invention supplies a practicable use of pose markings on entrained rigid bodies.

It is obvious to take geometry features of the nacelle as pose markings, which definitely corresponds to the state of the art. The way of proceeding to relate the pose measurements of the calibration to pose markings or geometry features on the nacelle itself, is heading in the right direction because a prerequisite for the univocal determination of a reference coordinate system is created. Then, a univocal coordinate system attached to the nacelle is present which is persistent.

But if one relates to geometry features of the nacelle, imponderables and imprecisions will be the result since the nacelle as a machine component is not manufactured in a highly precise way, and a suitable deterministic and reproducible support/attachment of a rigid body to be positioned is not given either. Metrologically as well, the assignment of a coordinate system is difficult. Precisely tapping a reference coordinate system within the scope of application by geometry features of the nacelle is complicated in manipulation.

If the hexapod calibrated on the way via parameter identification is then used, the pose markings possibly permanently attached to the nacelle will lose their importance since the access to them means a metrological complication. Instead, the planar surface of the nacelle, as shown in FIG. 3, defines a Z-direction by its perpendicular vector, engraved lines 201 on the upper nacelle side point into X- and Y-directions, and the origin of the reference coordinate system is on the Z-axis in a defined distance from the planar surface of the nacelle. Additional features such as the cable connection 202 differentiate the X-direction from the Y-direction.

The nacelle, however is not a suitable reference body, where a coordinate system may be attached, since the upper nacelle surface as a machine component is either very planarly milled nor otherwise manufactured in a highly precise way. There is no stopper present to be able to precisely position a rigid body on the platform. As discussed at the beginning, this leads to pose errors, since a suitable pose marking does not exist, and thus a precise coordinate transformation to the reference coordinate system is lacking.

It is described in the document WO 2017/ 064 392 A1 how all relevant geometry parameters of a Stewart platform can be determined, the kinematically relevant data of the hexapod thus should be ideally present finally measured in high precision. If the success of such a calibration is ideally taken as a basis, the calibration would have been executed completely as seen from the state of the art, and the positionings of the parallel robot theoretically would also be quite errorless.

In fact, one has only got a condition where the position of the upper 6 articulation points relative to the position of the lower 6 articulation points of each pose is known freed from errors. A rigid body resting upon the nacelle of the parallel robot and to be positioned or the nacelle itself have no defined relation to the position of the upper and lower articulation points. They are thus lacking a defined relation to a reference coordinate system, so that even an “ideally error-free” parallel robot cannot be positioned free from pose errors in the state of the art.

The technical progress disclosed in the document WO 2017/064392 A1, in particular relative to the defects of the so-called parameter identification, does not still alone lead to highly precise hexapod positionings.

“Kinematic couplings” are used already in many cases in hexapods manufactured by the Applicant. On the platform of the hexapods then the groove part of a “three groove kinematic coupling” is located. A ball part of the “three groove kinematic coupling” has a mounting for optical fibres. The base plate of the ball part is pressed onto the platform by magnet force. Such “kinematic couplings” offer a large degree of defined and reproducible positioning.

It is a task of the invention to provide a method and an assembly for a usage-related calibration of parallel kinematics of the kind discussed above, which includes in particular a programmable actuation, wherein the method and the assembly are intended to permit an improved positioning in cases of application requiring a highly precise positioning of measuring devices, tools, surgical instruments or similar borne on the parallel kinematics.

The invention recognizes prerequisites which are indispensable for highly accurate positioning with parallel kinematics but are not fulfilled in the state of the art. The invention names these prerequisites and discloses devices and methods which allow them to be fulfilled.

The solution of the problem with the provision of an available reference coordinate system refers according to the invention to kinematic interfaces, which can fulfil prerequisites of highest precision in the form of “kinematic couplings”.

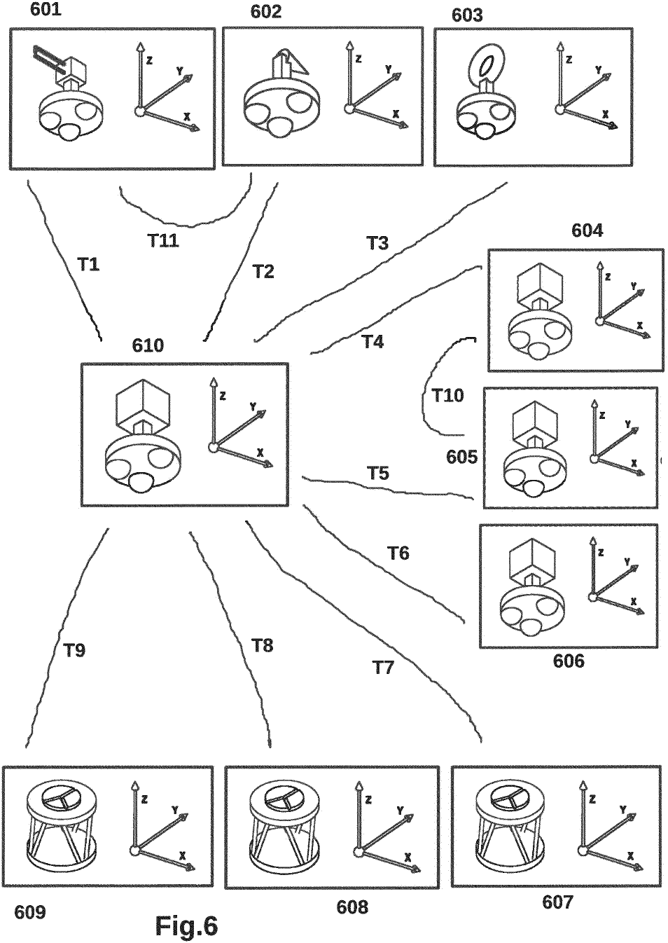

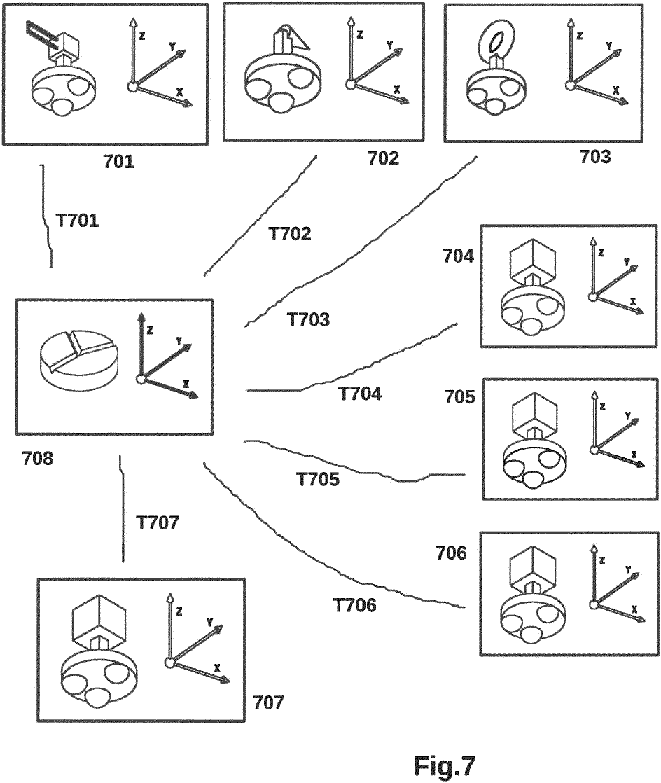

FIG. 5 shows a “three groove kinematic coupling” consisting of two parts, i.e. a groove part 502 having three grooves 501a, 501b, 501c, and a ball part 502 having three balls 502a, 502b, 502c.

If one puts a reference artefact onto the groove part of a robot, the first coordinate system thereof if fixedly connected to the nacelle. The position of the reference coordinate system may be indicated in the initialization phase of the robot in a highly precise manner by means of this coordinate system. The hereto required coordinate transformation is composed of linking two coordinate transformation. The first coordinate transformation is the one between the first coordinate system of the calibrating artefact and the first coordinate system of the reference artefact. The second coordinate transformation is the one between the reference coordinate system of the robot individuum and the first coordinate system of the calibrating artefact. Both coordinate transformations must be known to the controller of the robot. The coordinate transformation between the first coordinate system of a calibrating artefact and the first coordinate system of the reference artefact is independent from the robot individuum.

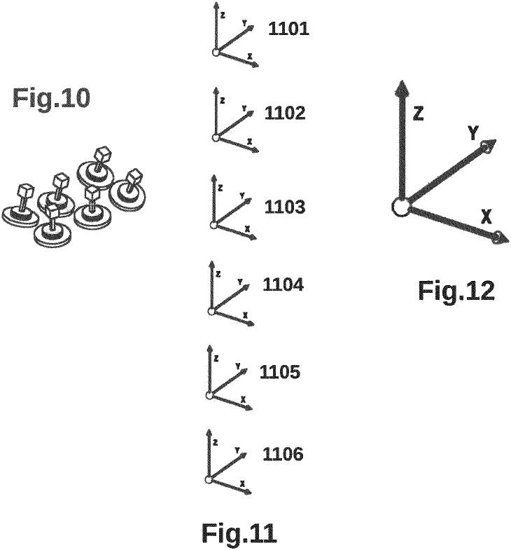

It is possible to get to the coordinate transformation between the first coordinate system of the calibrating artefact and the reference coordinate system of a robot exemplar in two different ways.
In a first variant, a reference artefact is already used in the calibration so that this coordinate transformation can be defined and determined in the scope of the calibration, see FIGS. 10 to 12 in this respect. If the calibration is performed with a mapping method, the mapping function’s reference coordinate system on which the mapping function is based, related to the first coordinate system of the calibrating artefact, would result in the coordinate transformation. If a calibration is performed in a way that geometry parameters of the hexapod are intended to be used as the parameters of a correcting illustration in the working room and/or configuration room, the reference coordinate system with the first coordinate system of the calibrating artefact would result in the searched coordinate transformation in determining the parameters here as well. A calibration in the kind of such a parameter selection leaves this possibility open. The misleading way of speaking of “parameter identification” for a calibration by “correcting” geometry parameters excludes such a possibility only seemingly, since the so-called parameter identification textually uses the geometry parameters only as the parameters of a fit function intended to minimize the error in the poses measured during calibration.

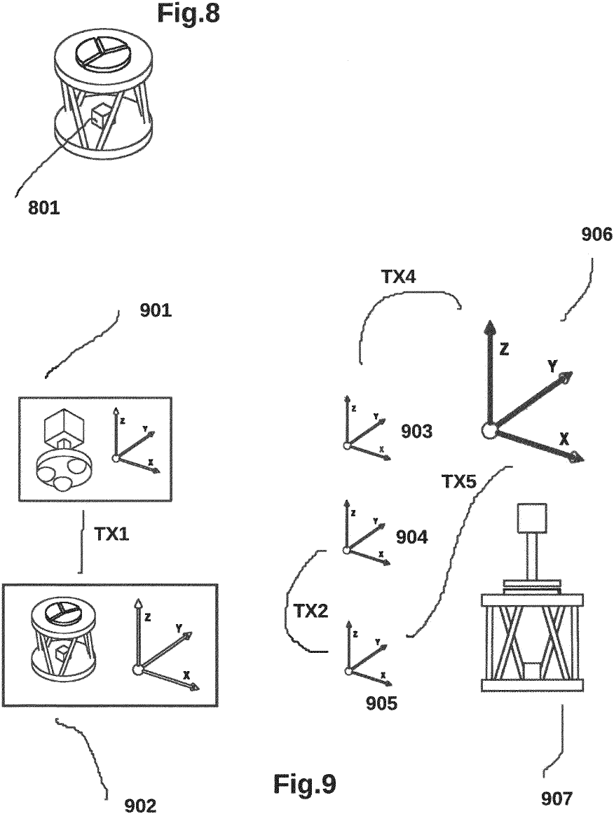

In a second variant which can be used in a highly precisely constructed and practically error-free built parallel robot, the nacelle has already a pose marking the space registration of which together with a constructively given coordinate transformation result in the reference coordinate system and thus enable the determination of the searched coordinate transformation between the reference coordinate system and the coordinate system of a calibrating artefact, see FIG. 8 and FIG. 9 in this respect. The determination of the searched coordinate transformation may be performed, for example, by means of a coordinate measuring machine detecting the pose marking on the hexapod and also the pose marking on the calibrating artefact.

Requirements as to the used groove parts and ball parts and the therefrom resulting univocal coordinate transformations between the coordinate systems of two reference artefacts will be explained in the following.

In a parallel robot, the platform of which bears a groove part, two reference artefacts can be fixed one after the other, and the coordinate transformation of the two coordinate systems of the reference artefacts can be metrologically determined.

If all ball parts of various reference artefacts are highly precisely and geometrically equally manufactured, the balls thus are shaped highly precisely and the centre points thereof build a highly precise triangle, one has the following property: the above-mentioned coordinate transformation between the coordinate systems of two reference artefacts is independent of the individuum of the groove part. In contrast to the ball parts of the reference artefacts, the groove parts are not required to be manufactured with highest precision. Since no particularly high precision requirements must be placed onto the groove parts, increased costs are not generated here.

The ball parts may be manufactured relatively simple in highest precision. The balls themselves may be purchased in highest precision, for example, as balls for ball bearings or as balls for probes as they are used in coordinate measuring machines. The highly precise arrangement in a triangle may be achieved when the balls are recessed, for example, halfway in blind holes during manufacturing, wherein fixed by a template, they can be cemented exactly in the desired triangular arrangement.

Therewith, the possibility is given to clamp a groove part in a coordinate measuring machine and to determine the coordinate transformation between respective two reference artefacts.

So as to adapt the movements of the robot to the position of a rigid body placed thereon, the following possibilities offer themselves:

### FIRST POSSIBILITY

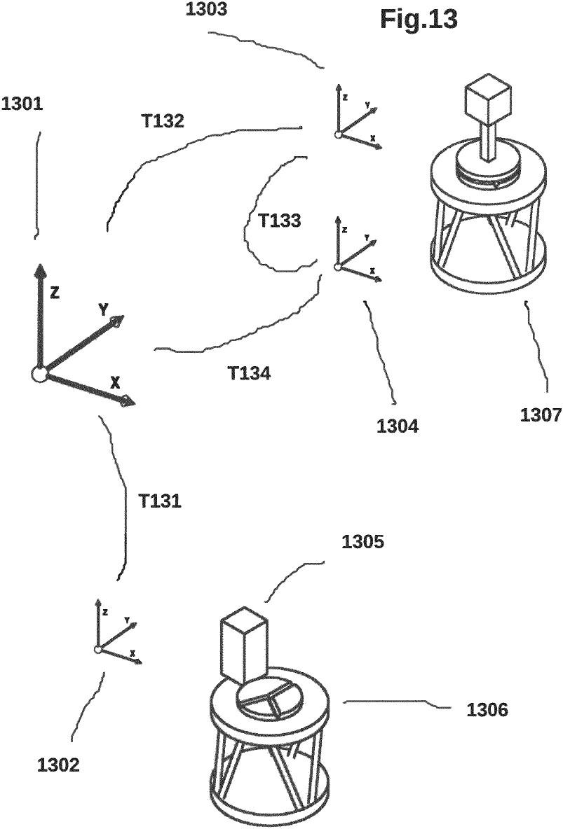

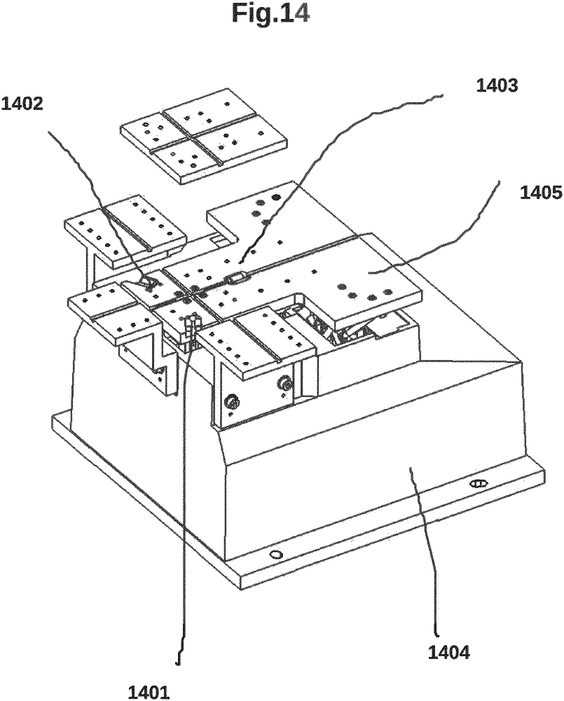

The parallel kinematics is placed into the measuring volume of a coordinate measuring machine (KGM), and the first coordinate system of the reference artefact is determined in the coordinate system of the KGM, and then the position of its coordinate system within the coordinate system of the KGM is then determined by means of pose markings on the rigid body to be positioned. See FIG. 12 in this respect. Therewith, the coordinate transformation between the body coordinate system and the reference coordinate system of the parallel kinematics is given. A corresponding coordinate transformation may be actuated on the controlled so as to move the body in its own coordinate system.

### SECOND POSSIBILITY

A mounting artefact such as a fibre mounting is used. The second coordinate system of this mounting is given by a coordinate transformation related to the first coordinate system of the reference artefact. Thus, the coordinate system of tools, work pieces, measuring devices can be related to the reference coordinate system of the hexapod. If a body is located in a mounting of a mounting artefact, also the coordinate system of this body in a corresponding configuration of the mounting and the shape of the body is given in relation to the reference coordinate system of the hexapod.

### THIRD POSSIBILITY

The nacelle surface must be highly precisely manufactured and have direction markings for this purpose, but also fitted stoppers are possible. Characteristics of the nacelle surface such as the direction vector of the nacelle plane and the direction of the grooves or position of the stopper surfaces are measured by means of a KGM and related to the reference coordinate system by means of a reference artefact. The rigid body is placed onto or attached to the nacelle as far as possible in exact orientation. This third possibility is restricted in its precision and generally exploits the advantages of the invention rather insufficiently.

### FOURTH POSSIBILITY

Reference artefacts are used having planar surfaces for orienting the rigid body, and which represent the pose marking thereof. FIG. 6 illustrates the relations of the various coordinate systems to one another defined in the introduction and their linking transformations.

The boxes 601 to 610 symbolize coordinate systems, this is the reason why a coordinate system is illustrated at the right for labelling. The drawing at the left from the coordinate system symbolizes the type or purpose of this coordinate system. The boxes 607, 608, and 609 in which a hexapod is illustrated represent reference coordinate systems of hexapods. The boxes having a reference artefact, 604, 605, and 606, designate the first coordinate system of a reference artefact.

Boxes having a tool plotted, here 601, 602, and 603, designate the tool coordinate system of a tool or the coordinate system assigned to a co-moved rigid body. The designation in the glossary for this is mounting artefact, the coordinate system is designated above as the second coordinate system of the mounting artefact.

In 601, the coordinate system is between the jaws of a forceps, thus the point of action of a gripper. In 602, the coordinate system relates to the tip of a conus-shaped material sample which has to be processed. This material sample thus is a work piece. In 603, the coordinate system relates to the position of a toroidal coil for measuring magnetic fields, thus to the measuring place of this measuring system. Into this category of tools, mirrors or mirror systems would also belong; these play a role in interferometric measurements. In the middle of FIG. 6, the first coordinate system of the calibrating artefact 610 is represented. This calibrating artefact does not differ in its type of construction and function from other reference artefacts, thus, for example, the reference artefacts represented in 604, 605, and 606. But it proves to be appropriate to select a reference artefact as the calibrating artefact so as to be able to relate comparisons of the pose of the first coordinate system of different reference artefacts uniformly to one another.

If the calibrating artefact 610 is attached onto a hexapod shown in 607, 608 or 609, by the three coordinate transformations T7, T8, and T9 determined in the course of the usage-related calibration, the positions and orientations of the respective reference coordinate system of the respective hexapod is given by the first coordinate system of the calibrating artefact, and the respective predetermined coordinate transformation rule.

Instead of the calibrating artefact, the reference coordinate system of the respective hexapod may here also be determined in relation to the first coordinate system of the respective reference artefact using the reference artefacts 604, 605, and 606, and the three coordinate transformations T4, T5, and T6 as interposed coordinate transformations.

The first coordinate systems of reference artefacts namely may be related to one another at any time by a pose detecting device to other first coordinate systems of other usage artefacts by a coordinate transformation. This relation is plotted by the coordinate transformations T4, T5, and T6 to the calibrating artefact. These three coordinate transformations supply the basis for the mentioned interposed coordinate transformations.

At the right side, three reference artefacts are seen by way of example. The coordinate transformations T4, T5, and T6 between the respective first coordinate systems have been determined according to the invention. Due to the mentioned mathematical group property, the coordinate transformations between all first coordinate systems of the reference artefacts and specifically also of the calibrating artefact can now be determined in pairs. For example, the coordinate transformation T10 between the first coordinate system 604 and the first coordinate system 605 from T4 and T5 can be calculated.

From this, it also follows that the coordinate transformation between the first coordinate system of an arbitrary reference artefact, for example, 604, and the usage coordinate system 607 can be determined from T4 and T7. For this calculation, the coordinate transformation between each of the first coordinate system of the reference artefact and the calibrating artefact is required, as well as the coordinate transformation between the first coordinate system of the calibrating artefact and the reference coordinate system of the hexapod.

This applies analogously to the coordinate transformations T1, T2, and T3, the plotted coordinate transformations T11 may be calculated from T1 and T2, for example. The coordinate transformation between a first coordinate system of a reference artefact and the first coordinate system of a mounting artefact may likewise be calculated in this manner.

It is important that each reference artefact to which a coordinate transformation can be indicated to a calibrating artefact, can adopt the task of a calibrating artefact in an unlimited manner. So as to avoid error reproductions, however, it is recommended to obtain the calibrating artefact for comparative measurements as a reference, as it happened, for instance, in physics in former times with the term “primary kilogramme”.

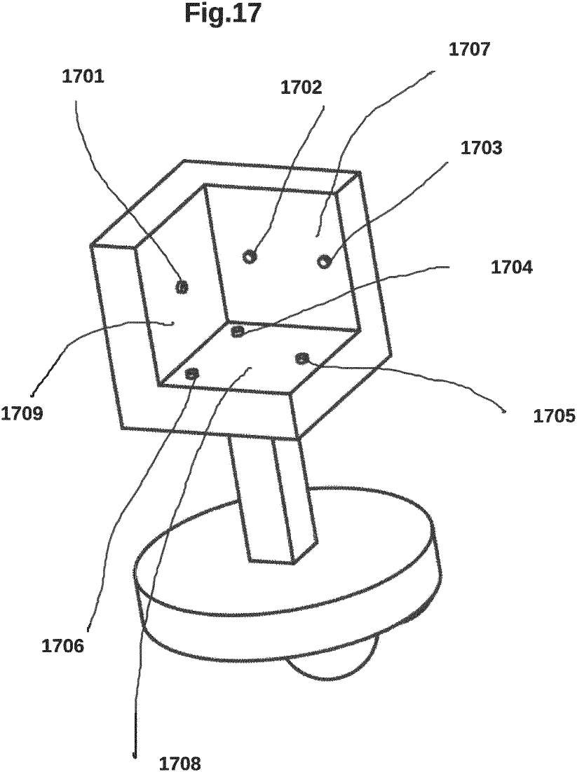

The mentioned relations of the coordinate transformations to one another enable a -defective-hexapod to be replaced by a replacement hexapod, wherein the reference coordinate system of the replacement hexapod is positioned identically to the reference coordinate system of the defective hexapod in relation to the world coordinate system. First of all, the functionalities are required in this case for the numerical execution of coordinate transformations by means of the actuating controller. Second, a device and a method are required by means of which the pose marking of a reference artefact exemplary can be brought into the same position in the replacement hexapod as in the defective hexapod. The hexapods work in this case as pose detecting devices. The leg lengths in given poses are read out in the hexapod in the function as pose detecting device, the associated pose is calculated from this and evaluated in the scope of the method. Each pose marking mounted on a hexapod and having the form of a cuboid may be positioned in analogy to the so-called rule 3-2-1 defined in the tolerance management, in that 6 surface points are brought into one stop contact. In this case, the first plane of the cuboid is designated as a primary plane, and is contacted with three probe tips, the second plane is designated as a secondary plane, and is contacted with 2 probe tips, the third plane finally as tertiary plane is contacted with one probe tip. Hereby, the position of the cuboid in space is determined in its 6 degrees of freedom. A suitable device for this stop contacting is shown in FIG. 17.

If highly precise approximation switches are used as the probe tips, the alignment of the cuboid pose marking to the six-point pose markings can be performed automatically and iteratively.

The arrangement of the 6 approximation switches themselves may be understood as a pose marking. A hexapod having a reference artefact equipped in this kind as a pose marking, may work cooperatively in the same coordinate system by a rendezvous with a hexapod bearing a cuboid-bearing reference artefact, which has a relation to both of the reference coordinate systems.

The metrological determination of the elements of the transformation group acting upon the first coordinate system of reference artefacts and mounting artefacts will be explained in the following.

The metrological survey of the transformations is represented in FIG. 7.

The survey of the transformations is performed by means of pose detecting devices. In a preferred embodiment, a coordinate measuring machine serves for this purpose, by means of which pose markings are scanned.

The coordinate system, in which the pose detecting device is measuring, is represented in black in 708. The precise position of this coordinate system is not important, it is getting the meaning of an auxiliary coordinate system in the method.

In the box next to this auxiliary coordinate system, the groove part of a “three groove kinematic coupling” is represented. To an interface part itself a coordinate system cannot be assigned. The interface part is fixedly anchored in the measuring space of the pose detecting device and immovable relative to the auxiliary coordinate system.

Within the measuring space of the pose detecting device, the groove part of a kinematic interface is fixed. The calibrating artefact 707 is place onto this groove part, and the position of its first coordinate system is determined in the auxiliary coordinate system. The same measurements are executed with the other reference artefacts 704, 705, and 706. Likewise, the poses of the second coordinate systems of the mounting artefacts 701, 702, and 703 are determined. In the same way, the poses T701, T702, T703, T704, T705, T706, and T707 may immediately be determined, which are related to the auxiliary coordinate system, and the different first or second coordinate systems of the reference artefacts and the mounting artefacts may be related to one another. By means of the transformation T707 of the first coordinate system of the calibrating artefact, a standardization of the transformations T701 to T706 to the calibrating artefact is possible.

This method requires all of the ball parts of the reference artefacts and mounting artefacts to be of a highly precise and similar manufacture. The same high requirements do not need to be placed on the equality of the groove parts used in the scope of the invention. Each precisely manufactured groove part namely uniquely defines the position of a ball part attached to it, and, as a consequence the pose of similar highly precisely manufactured ball parts also is defined uniquely and equally.

The detection according to the invention of an available reference coordinate system in a hexapod manufactured in a highly precise manner, is executed here according to FIG. 8 and FIG. 9, wherein the hexapod itself has a likewise highly precise pose marking 801:

The highly precisely manufactured hexapod here represented by way of example, already has an available coordinate system due to the presence of a pose marking 801 designed here in a cuboid form. The position of the reference coordinate system of the hexapod is given by a coordinate transformation referring to the reference coordinate system from the space registration of the pose marking. This known coordinate transformation between the space registration of the pose marking and the reference coordinate system results from the kinematic relevant geometry parameters realized in high precision, whereto the pose marking here belongs also.

The pose marking is here attached to the bottom plate, but such a pose marking may also be attached to the nacelle. The kind of pose marking is likewise selectable, by way of example, planar surfaces in a highly precise orientation attached to the platform or three non-collinear balls may form a pose marking.

The mentioned highly precise manufacturing relates to the position of the kinematically relevant components, in particular the local vectors and the direction vectors of the articulations. The position and orientation of the pose marking likewise needs to be defined in a highly precise manner in the same coordinate system.

It is shown in FIG. 9, how the coordinate transformation between the first coordinate system of the calibrating artefact and the reference coordinate system of the hexapod can be realized in a pose detecting device.

The coordinate system 906 represents the coordinate system of the pose detecting device. Relative to this coordinate system, the pose T×5 of the coordinate system 905 of the pose marking 801 and the pose T×4 of the first coordinate system of the calibrating artefact 903 is measured.

The coordinate transformation T×1 representing the searched relation between the reference coordinate system 902, 904 of hexapod 907 and the first coordinate system 903 of the calibrating artefact 801, i.e. the coordinate transformation between the coordinate systems 903, 901, and 904, can be determined as follows:

The pose T×4 of the first coordinate system 903 of the reference artefact is measured with respect to the coordinate system of the pose detecting device. The coordinate systems 903, 904, and 905 are drawn in black since they are related to the auxiliary coordinate system 906.

Then, the pose T× 5 of the pose marking of the hexapod with respect to the auxiliary coordinate system 906 is measured in an analogous way. This coordinate transformation is linked to the coordinate transformation T×2 so that the pose of the reference coordinate system relative to the auxiliary coordinate system is given. In calculating T×1 from the mentioned coordinate transformations, the reference to the auxiliary coordinate system is omitted.

The representation of an available reference coordinate system can be performed in the course of calibrating measurements as follows:

Kinematic calibrating measurements are based on measuring the hexapod poses in a plurality of different poses, wherein the calibration is intended to cause a correction of the pose deviations, consisting of a comparison of the measured poses to the commanded poses.

Initially, a reference coordinate system needs to be taken as a basis for the pose commands so as to be able to define poses.

Such a definition could have been performed according to FIGS. 1 and 2.

Then the platform is commanded into a plurality of poses, wherein the hexapod has the calibrating artefact attached. A few exemplary poses the calibrating artefact adopts, are shown in FIG. 10. In each of these poses, the first actual coordinate system 1101, 1102, 1103, 1104, 1105, 1106 of the attached calibrating artefact with respect to the coordinate system of a pose detecting device is measured such as illustrated in FIG. 11. The number of the pose measurements required for calibrating as a rule is three-digit.

Now, the pose of a reference coordinate system in the coordinate system of the pose detecting device is calculated from the plurality of the measured poses by an equalization calculus, and this is related to the position of the first coordinate system of the calibrating artefact in the initialization pose of the hexapod. Thus, the position of the reference coordinate system is defined relative to the first coordinate system of the calibrating artefact

The fact that the means of the equalization calculus is selected here is due to the inadequate precisions of an uncalibrated hexapod. These inadequacies lead to -slight- inconsistencies in the position of the reference coordinate system. Since the pivot points and the directions of movement of the hexapod slightly vary depending on the actually adopted pose.

As soon as the reference coordinate system is defined as described, it is available since it relates to the pose of the first coordinate system of the calibrating artefact. Following this, a calibration is made on the basis of the measurement results and the reference coordinate system. This calibration is intended to secure that the deviations of the commanded poses to the measured poses are minimized or eliminated.

For the pose determination of bodies connected to the nacelle without using an interface, the following should be pointed out:

Rigid bodies can be fixedly mounted on the nacelle. For example, “kinematic couplings” are not suited for transferring large forces and moments, which possibly requires directly mounting a body on the nacelle. It is true that an alternatively usable “quasi-kinematic couplings” can transfer larger forces and moments, but they are not determined kinematically, and are less suited than “kinematic couplings” for high precision applications. Moreover, even in “quasi-kinematic couplings” there are restrictions in terms of force and moments, and the alternative use of these kinematic interfaces would impede the uniformity of the interfaces used.

In applications in which a work piece or a sensor is connected in a form-fit manner (frictionally rigid), for example, using machine screws, or in a substance-fit manner (for example, adhesion, welding, brazing) to the platform, the precise pose of the attached body initially is not precisely determined relative to the reference coordinate system of the hexapod.

The proceeding shown in FIGS. 12 and 13 here offers itself.

The hexapod is initially fixed in the working space of a pose detecting device and is commanded into its initialization pose. Within the coordinate system of the pose detecting device 1301, which is an auxiliary coordinate system, the pose T132 of the first coordinate system 1303 of a reference artefact is initially determined which is attached to the hexapod. Therewith, the pose 1304 of the reference coordinate system of the hexapod relative to the auxiliary coordinate system of the pose detecting device is also known as the coordinate transformation T134. T133 represents the predefined first transformation rule and describes the coordinate transformation between the first coordinate system of the calibrating artefact and the reference coordinate system of the hexapod.

In the next step, the hexapod is extracted the reference artefact - if required for reasons of space - and the sample piece is fixed to the hexapod. The sample piece 1305 is a cuboid structure which is glued to the platform in the example.

Then the pose of the work piece is measured in that the pose detecting device determines the coordinate system 1302 by means of pose markings of the work piece. Hereby, the transformation T131 is obtained.

The transformations T131 and T134 now obtained result in the pose of the work piece relative to the reference coordinate system 1304 of the hexapod represented in 1306 and 1307.

FIG. 14 shows a parallel robot, 1404 designates the chassis, 1405 designates the nacelle. The nacelle has a groove part, the grooves are shown in 1401, 1402, and 1403. In this robot, the grooves are realized by two parallel recessed cylinders 1401 in each case.

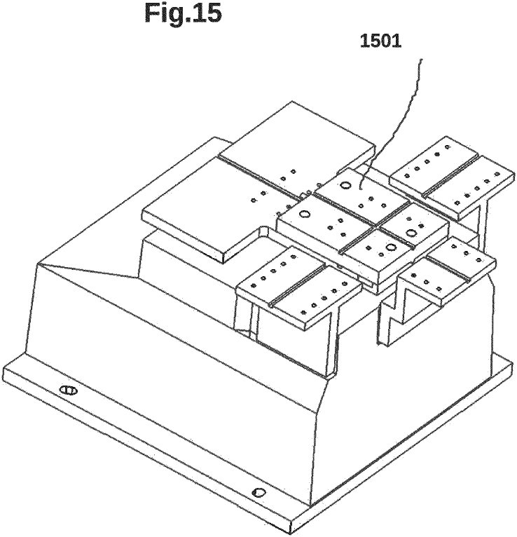

FIG. 15 shows the robot of FIG. 14, the nacelle here has a ball part 1501 attached. The view onto the balls is concealed.

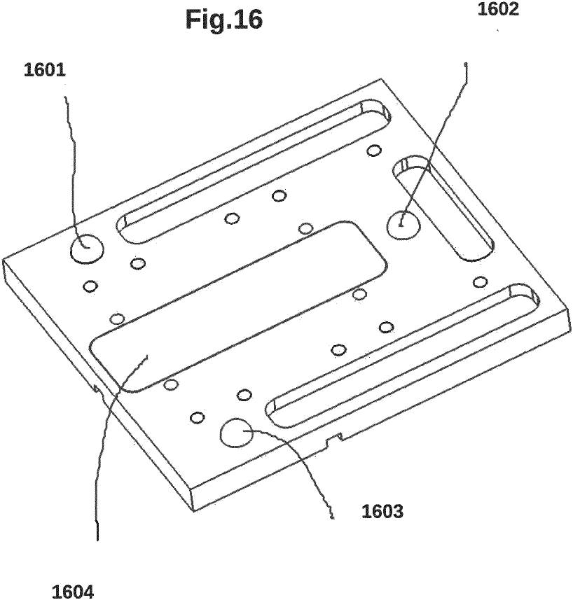

FIG. 16 shows the underside of the ball part 1506. The balls 1601, 1602, and 1603 of the ball parts as well as a holding magnet 1604 can be recognized.

The realization of the invention is not restricted to the examples described above and the aspects explained, but is possible in a plurality of modifications which are within the scope of expertise action.

FIG. 17 shows a reference artefact in which the pose marking consists of 6 scanning points. 1708 designates the primary plane consisting of the three points 1704, 1705, and 1706, the secondary plane is shown with 1707 and has the associated points 1702 and 1703, the tertiary plane is designated 1709 and bears the point 1701. The shown pose marking can uniquely be applied to a cuboid pose marking, so that two coordinate systems can be brought into relation with one another by coordinate transformations.

If two of such pose markings are rigidly connected to one another, or a cuboid pose marking is rigidly connected to such a pose marking, coordinate systems may arbitrarily be related to one another by a coordinate transformation in the manner of a construction kit.

1. A method for the usage-related calibration of a parallel kinematics having a programmable actuation, including the steps of:
detachably and tilt-proofed attaching of a separate pose marking body in a uniquely defined position and angular orientation on the platform or a base plate of the parallel kinematics by means of a kinematic coupling,
pose detecting of the pose marking body by means of a pose detecting device, and determining a pose marking coordinate system in the coordinate system of the pose detecting device,
determining a calibrated reference coordinate system of the parallel kinematics from the pose marking coordinate system on the basis of a predetermined first coordinate transformation rule, and
storing the calibrated reference coordinate system of the parallel kinematics in the actuator thereof or a measuring software,
pose detecting of the world coordinate system by means of a coordinate measuring device, and determining the world coordinate system in the coordinate system of the pose detecting device, and
storing the pose of the world coordinate system and making available the two stored coordinate systems or the coordinate transformation between the two coordinate systems for adapting the hexapod movements with respect to the world coordinate system.

2. A method for the usage-related calibration of a parallel kinematics having a programmable actuation, including the steps of:
detachably and tilt-proofed attaching of a separate pose marking body in a uniquely defined position and angular orientation on the platform of the parallel kinematics by means of a kinematic coupling, orientating the pose marking of the pose marking body to the pose marking of an object by the movement of the platform, wherein the coordinate system of the object pose marking is known in the world coordinate system,
using the hexapod as a pose detecting device by reading-out its pose after its orientation,
numerically determining of the coordinate transformation between the calibrated reference coordinate system of the hexapod and the world coordinate system for the out-read hexapod pose, a predetermined transformation rule and the coordinate system of the object pose marking in the world coordinate system for adapting the hexapod movements with respect to the world coordinate system, and storing this coordinate transformation, and
making available the calculated coordinate transformation for adapting the hexapod movements with respect to the world coordinate system.

3. The method according to claim 2,
wherein the object is a pose marking body of a second parallel kinematics, and
wherein the world coordinate system is the calibrated reference coordinate system of the second parallel kinematics, and
wherein the calculated coordinate transformation is the coordinate transformation between the two calibrated reference coordinate systems of the parallel kinematics.

4. The method according to claim 3, wherein the parallel kinematics are commanded cooperatively by the known coordinate transformation between their reference coordinate systems in the same coordinate system.

5. The method according to claim 1, wherein the parallel kinematics is a hexapod, and the platform of the parallel cinematics is the nacelle of the hexapod.

6. The method according to claim 1, wherein the pose marking body has a highly precisely manufactured cuboid, and the spatial position of three delimitation surfaces of the cuboid is detected which are perpendicular to one another.

7. The method according to claim 1, wherein the pose marking body has a marking carrier having three non-collinear balls, and the spatial position of the ball centres of the balls is detected.

8. The method according to claim 1, wherein a statically determined kinematic interface is provided as the kinematic coupling.

9. The method according to claim 8, wherein a groove part-ball part pair with a corresponding geometry of the groove part and ball part is used as the kinematic coupling, wherein the groove part is rigidly fixed to the platform or base plate of the parallel kinematics, and the ball part is rigidly fixed to the separate pose marking body.

10. The method according to claim 1, wherein the first coordinate transformation rule is determined in the manufacturing of the parallel kinematics in a production-related primary calibration, and is stored in the programmable control of the parallel kinematics.

11. The method according to claim 10, wherein the production-related primary calibration is performed in analogy to the usage-related calibration using a separate pose marking body placed on top of the platform or base plate.

12. The method according to claim 11, wherein, in the case of a highly precisely constructed and manufactured parallel kinematics, the pose marking is directly attached to the platform, and the first coordinate transformation rule is determined from this.

13. The method according to claim 1, wherein
on the platform of the parallel kinematics, a tool is rigidly fixed, and a tool coordinate system is determined by means of the coordinate detecting device,
a second coordinate transformation rule is determined from the pose marking coordinate system and the tool coordinate system, and
in the programmable control of the parallel kinematics, a control algorithm for the movement of the tool is stored, in which the position of the tool is related to the calibrated reference coordinate system of the parallel kinematics by means of the second coordinate transformation rule.

14. An assembly for the usage-related calibration of a parallel kinematics having a programmable actuation, arranged for executing the method according to claim 1, having:
a pose marking body, and
a cinematic coupling for detachably and tilt-proof attaching the pose marking body to the platform of the parallel kinematics in a uniquely defined position and angular orientation.

15. The assembly according to claim 14, further including a coordinate detecting device for detecting the coordinates of the pose marking and determining a pose marking coordinate system.

16. The assembly according to claim 14, wherein the pose marking body has a highly precisely manufactured cuboid or a marking carrier having three non-collinear balls fixedly attached thereto.

17. The assembly according to claim 14, wherein the kinematic coupling is a statically determined kinematic interface.

18. The assembly according to claim 17, wherein the kinematic coupling has a groove part that can be rigidly connected to the platform of the parallel kinematics, and a ball part that can be rigidly connected and corresponds to the geometry of the latter, and means for detachably holding the groove part on the ball part which are formed in particular as magnetic elements.
